(19) United States
(12) Patent Application Publication
(10) Pub. No.: US 2005/0008330 A1
(43) Pub. Date: Jan. 13, 2005

(54) Moving image editing apparatus and its control method

(75) Inventor: Shinichiro Uno, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/882,259

(22) Filed: Jul. 2, 2004

(30) Foreign Application Priority Data
Jul. 9, 2003 (JP) 2003-194550

(51) Int. Cl. H04N 5/93; G11B 27/00

(52) U.S. Cl. 386/52; 386/55

(57) ABSTRACT

In response to a request for deletion of intermediate portion of moving picture data stored on a random-accessible storage medium, data corresponding to the request is substantially deleted, and the portion corresponding to the deletion request is excluded from the subject of reproduction in precise frame units. When a request for deletion of intermediate portion of moving picture stream data has been made, the data from a GOP immediately after a deletion start position to a GOP immediately before a deletion end position is deleted. Then a play list is generated to exclude frames from the deletion start position in a GOP designated with the deletion start position and frames before the deletion end position in a GOP designated with the deletion end position from the subject of reproduction.

### CLAIM OF PRIORITY

This application claims priority from Japanese Patent Application No. 2003-194550 filed on Jul. 9, 2003, the entire contents of which are incorporated herein by reference.

### FIELD OF THE INVENTION

The present invention relates to an editing technique for MPEG-2 stream data where coded digital moving picture data and digital audio data are time-division multiplexed based on a digital moving picture/audio compression standard (Moving Picture Experts Group: MPEG).

### BACKGROUND OF THE INVENTION

To perform edits on moving picture data recorded on a disk medium using a moving picture data recording/reproduction device such as a disk camcorder, deletion of moving picture data in file units or virtual editing (non-destructive editing) using a play list is generally performed. Further, upon actual editing (destructive editing) of file, if the moving picture data is MPEG-2 format data, editing is made merely by unit of recording called GOP (Group Of Pictures). When frame level editing is to be performed, the moving picture data must be duplicated on a PC or editing device and subjected to re-encoding then rewritten on the disk (disclosed in, e.g., Japanese Patent Application laid-open Nos. 08-070422 and 11-313288).

However, unnecessary data exists in recorded data not infrequently, when, for example, a user has forgotten to depress a recording stop button. If a play list is used, reproduction can be made such that unnecessary data seemingly does not exist, however, the information actually exits on the recording medium. Further, in the present circumstances, it is impossible to delete only such unnecessary data as described above. Further, in GOP level actual editing, deletion or the like is performed in a position shifted from a position designated by a user, and upon reproduction, the result of edition is different from that intended by the user. Further, in a case where re-encoding is performed and frame level actual editing is performed, the image quality is degraded.

### SUMMARY OF THE INVENTION

The present invention has been made in consideration of the above situation, and provides a moving picture data recording/reproduction apparatus for moving picture data on a random-accessible storage medium and moving picture data with a related file group. Upon frame level actual editing, editing by GOP is performed by only updating a file system without changing moving picture data itself. Upon reproduction, the moving data is reproduced in accordance with play list information by frame within a range designated by a user. Further, as moving picture data related files, a moving picture management file, a thumbnail file, a meta data file, a time map information file and the like, are also updated. In this arrangement, frame level actual editing can be performed by merely updating the file system and generating a play list without re-encoding.

To solve the above problem, the video/audio signal editing apparatus of the present invention is a moving picture editing apparatus for processing plural moving picture files respectively including coded moving picture data and play list data indicating a procedure of reproduction of the plural moving picture files recorded on a recording medium, comprising: designation means for designating deletion start position and deletion end position of the moving picture data so as to request deletion of a part of the moving picture data, wherein the designation means being capable of designating the deletion start position and the deletion end position in smaller units than predetermined units related to coding processing on the moving picture data; deletion processing means for, in correspondence with a deletion request from the designation means, deleting the moving picture data from the recording medium in the predetermined units related to the coding processing on the moving picture data; and play list processing means for, in correspondence with the deletion request from the designation means, changing contents of the play list data so as to reproduce the moving picture data to the deletion start position and continuously from the deletion end position.

More particularly, provided is a moving picture editing apparatus for editing moving picture data in MPEG-2 program stream format stored on a random-accessible storage medium, comprising: detection means for detecting an editing designation input to designate a deletion start position and a deletion end position in the moving picture data; deletion means for, if the detection means has detected the editing designation input, deleting data from a GOP immediately after a GOP including the deletion start position to a GOP immediately before a GOP including the deletion end position by updating file management information of the storage medium; and play list generation means for, if the detection means has detected the editing designation input, generating a play list, excluding frames from the deletion start position in the GOP including the deletion start portion and frames before the deletion end position in the GOP including the deletion end position, on the storage medium.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an explanatory diagram showing frame level editing processing according to an embodiment of the present invention;

FIG. 2 is a table showing file system information of moving picture data before editing;

FIG. 3 is a table showing the file system information of actually edited moving picture data;

FIG. 4 is a table showing play list information upon reproduction of the actually edited moving picture data;

FIG. 5 is a block diagram showing the relation between a storage medium and its reading/writing processing unit according to the embodiment;

FIG. 6 illustrates a directory structure according to the embodiment;

FIG. 7 is an explanatory diagram showing the structure of moving picture data according to the embodiment;

FIG. 8 is an example of the structure of a moving picture management file according to the embodiment;

FIG. 9 is an example of the structure of a time map information file according to the embodiment;

FIG. 10 is an example of the structure of a play list file according to the embodiment;

FIG. 11 is a flowchart showing a procedure of the editing processing by frame according to the embodiment;

FIG. 12 illustrates the directory structure according to another embodiment of the present invention;

FIG. 13 is an example of the structure of the moving picture management file according to the other embodiment;

FIG. 14 is a block diagram showing a video/audio signal editing apparatus according to the embodiments; and

FIGS. 15A to 15C are tables showing the structure of a play list and descriptions before and after moving picture editing.

### DETAILED DESCRIPTION OF THE PREFERRED EMBODIMENTS

Hereinbelow, preferred embodiments of the present invention will now be described in detail in accordance with the accompanying drawings.

<First Embodiment>

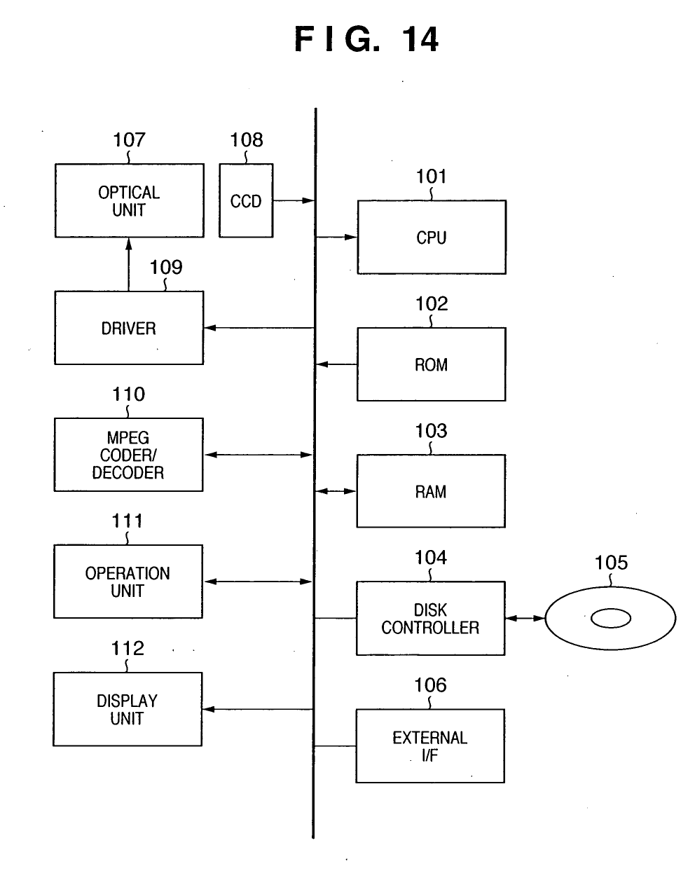

FIG. 14 is a block diagram of a digital video camera as a video/audio signal editing apparatus to which an embodiment of the present invention is applied. In FIG. 14, reference numeral 101 denotes a CPU which controls the entire apparatus; 102, a ROM in which a control processing program for the CPU 101 is stored; 103, a RAM used as a work area for the CPU 101; and 104, a disk controller for reading/writing from/on a writable optical disk 105 as a random-accessible storage medium (e.g., a DVD-RAM, a −R/−RW or a +R/RW).

Numeral 106 denotes an external interface (I/F) having an AV terminal for outputting video data stored on the optical disk 105, an AV input terminal, and an IEEE 1394 interface for digital data communication with an external device such as a personal computer. Numeral 107 denotes an optical unit; 108, a CCD as an image sensing device; 109, a driver which controls focusing, zooming, aperture and the like of the optical unit 107; 110, an MPEG coder/decoder which performs MPEG-2 compression coding and decoding; 111, an operation unit having various operation switches and buttons, a dial and the like; and 112, a display unit which displays an image obtained by image sensing or various menus and the like.

In the above construction, when a picture recording switch is turned ON, an image obtained by the CCD 108 is subjected to MPEG-2 coding by the MPEG coder/decoder 110, and the coded stream data is written on the optical disk 105 under the control of the disk controller 104. Note that upon reproduction of already written image, a designated MPEG-2 stream data is read via the disk controller 104, then subjected to decoding by the MPEG coder/decoder 110, and the result of decoding can be displayed on the display unit 112, otherwise, can be edited.

Hereinbelow, partial deletion of MPEG-2 stream data according to the present embodiment will be described. Note that in the following example, the MPEG-2 stream data as the subject of editing is already written on the optical disk 105 (recorded upon image sensing or recorded as an AV signal inputted from an external AV terminal). Further, upon partial deletion processing, it is necessary to designate an MPEG stream to be deleted and designate a deletion start position and a deletion end position in the stream. For example, an editing section is determined by designating an editing start position and an editing end position at desired timings from the operation unit 112 during reproduction. Note that the present invention is not limited to the above setting of the editing section.

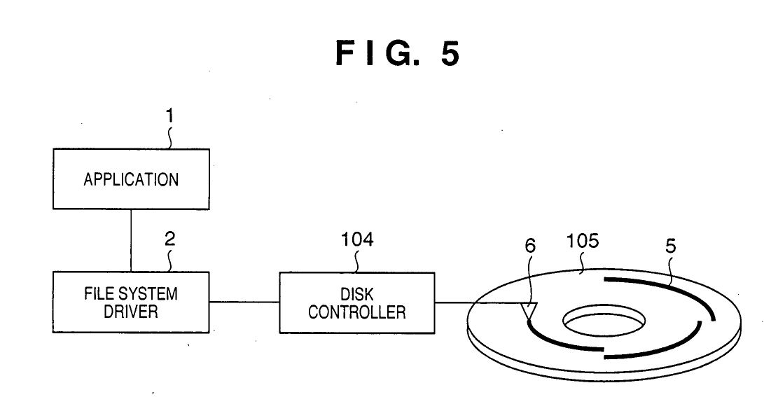

FIG. 5 is a conceptual block diagram showing a part around the optical disk 105 as a storage medium related to moving picture data recording/reproduction by a disk camcorder or the like and the disk controller 104.

In FIG. 5, numeral 1 denotes an application program which instructs a file system driver 2 to perform recording/reproduction of file with respect to the disk medium or editing. The file system driver 2 checks an available area on the disk and a recording position of the file, and instructs the disk controller 104 to perform data reading/writing with respect to the disk 105. At this time, the application program 1 does not examine the position of data on the disk, but the file system driver 2 checks the available area on the disk and records the data, or searches for the position of data on the disk and reads the data. The disk controller 104 actually writes or reads data on/from the disk 105. Numeral 5 denotes data actually written on the disk 105, which is read/written by a recording/reproduction head 6.

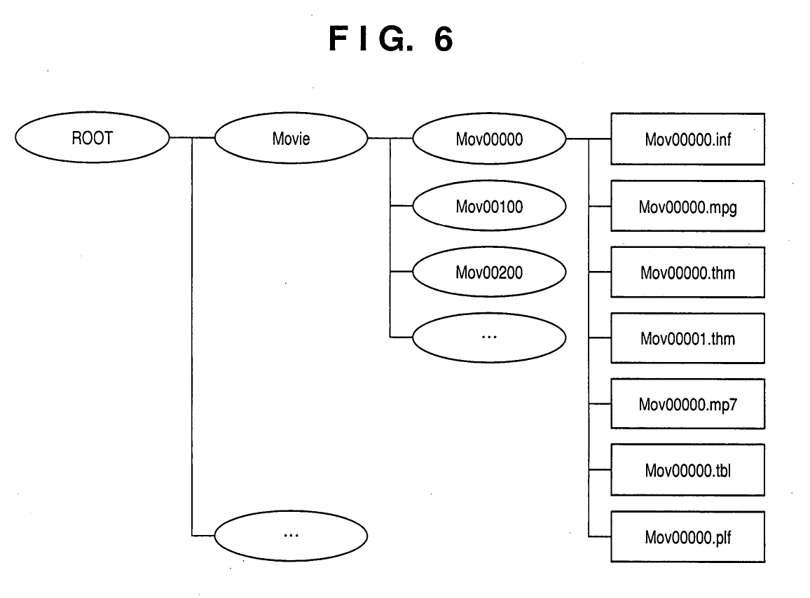

FIG. 6 shows a directory structure according to the present embodiment, in which one directory is assigned to one moving picture data. Under a Movie directory, individual moving picture directories each having a name of Mov+5-digit number and including a moving picture file main body (.mpg), a moving picture management file (.inf), a thumbnail file (.thm), a meta data file (mp7), a time map information file (.tbl), a play list file (.plf) and the like (characters following the dots are extensions indicating respective file types). As file names of these files except the thumbnail file, the directory name with the respective extensions are used. Plural thumbnail files can be generated for one moving picture file, and in such case, as file names of the thumbnail files, the plural the same file name is used, but a 2-digit number following the file name are different. As described later, information indicating the correspondence between a read thumbnail and a portion of a stream is described in the moving picture management file. In a case where an individual moving picture directory is added, an upper 3-digit number in the directory name is changed. If the number of the directory name has reached the limit, the 3 alphabet characters of the directory name is changed. Note that the above naming is merely an example and it does not pose any limitation on the present invention.

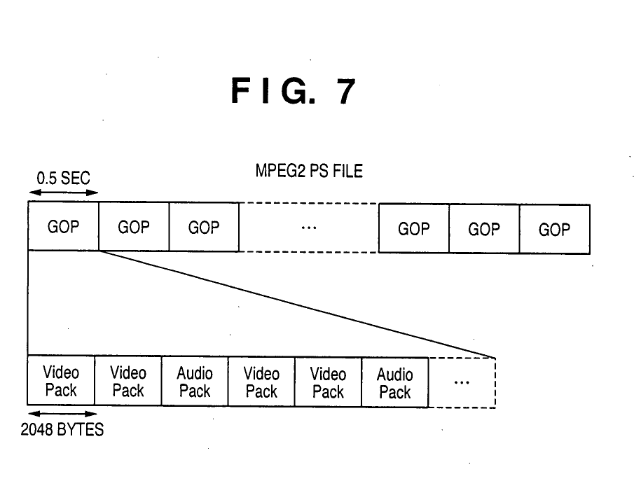

FIG. 7 shows the structure of moving picture data according to the present embodiment, in which the data is compression-encoded in the MPEG-2 PS format. The MPEG2 PS file is comprised of groups of pictures (GOPs). In the present embodiment, one GOP corresponds to 0.5 seconds (15 frames). Further, the GOP is comprised of mixed Video and Audio Packs. In the present embodiment, the capacity of one Pack is 2048 bytes. Note that for the sake of simplicity of explanation, in the file system of the present embodiment, the sector size is 2048 bytes, i.e., one Pack corresponds to one sector. The boundary between the GOPs and that between sectors always correspond with each other.

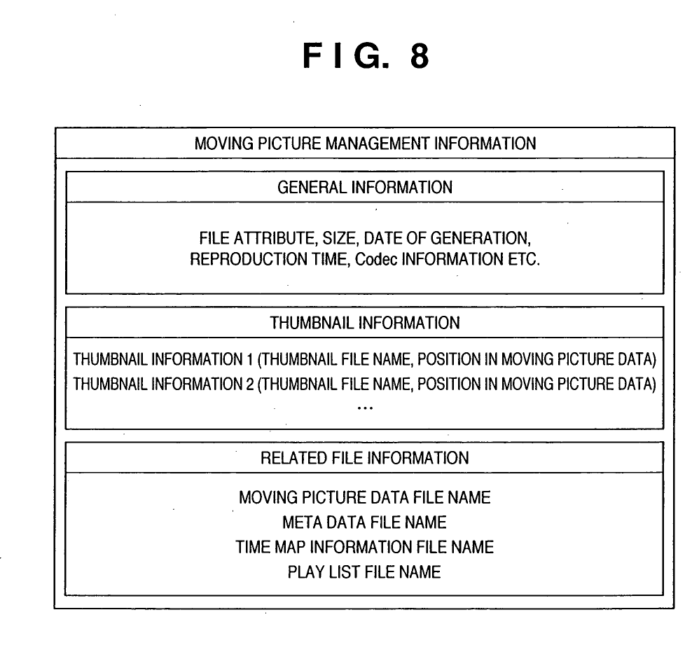

Next, moving picture related files will be described. FIG. 8 shows the structure of the moving picture management file according to the present embodiment having general information, thumbnail information and related file information. The general information includes general moving picture related information such as the attribute and size of moving picture file, the date of generation, reproduction time, and Codec information. The thumbnail information has a table showing the correspondence between thumbnail file names of plural thumbnails and their positions in the moving picture data. The related file information indicate managed moving picture data and file names of related file group, for association between the moving picture data and its related file group.

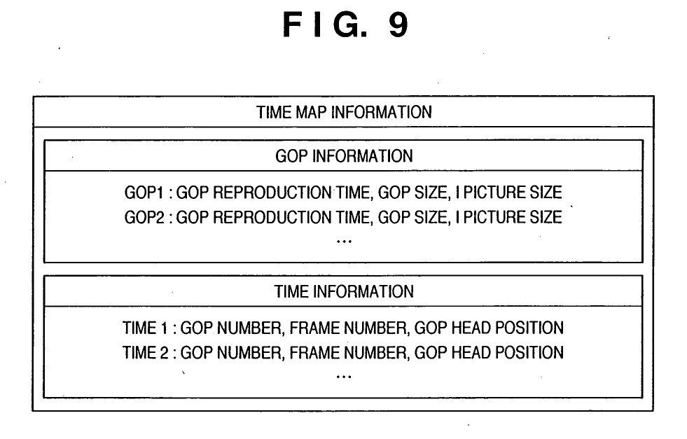

FIG. 9 shows the structure of the time map information file according to the present embodiment having GOP information and time information. The time map information is a table for conversion between reproduction time (e.g., seconds) from the top of stream and data size (e.g., bytes). The conversion table is used upon reproduction in the middle of a stream or upon special reproduction. The GOP information is a table where reproduction time (frames), size (bytes) and I picture size (bytes) are described for all the GOPs included in the moving picture data. The time information is a table where a GOP number and a frame number, and a position (bytes) from the top of the moving picture data to the top of the GOP are described by predetermined interval (e.g., 10 sec). The reproduction time from the top of the moving picture data can be converted to byte position by using the GOP information and the time information.

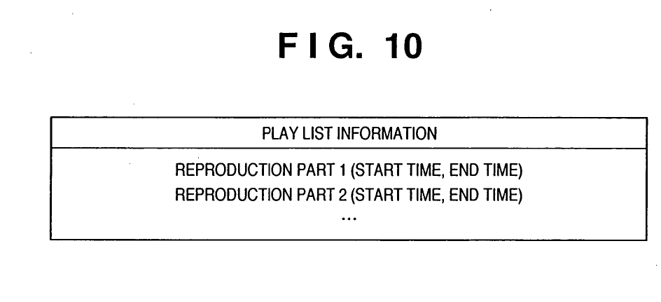

FIG. 10 shows the structure of the play list file according to the present embodiment, showing an actually reproduced portion upon reproduction of moving picture data. In the play list file, start time and end time are described for each reproduced portion, and designation can be made by frame. Note that time designation may be made only with time information or a combination of time (sec) and frame number. In the present embodiment, the time designation is made with only time information.

Further, as the thumbnail file, a JPEG thumbnail file in conformity with the DCF standard. The meta data file including camera data, user information and the like has a structure in conformity with the MPEG 7 standard.

Next, a particular example of actual frame level editing will be described.

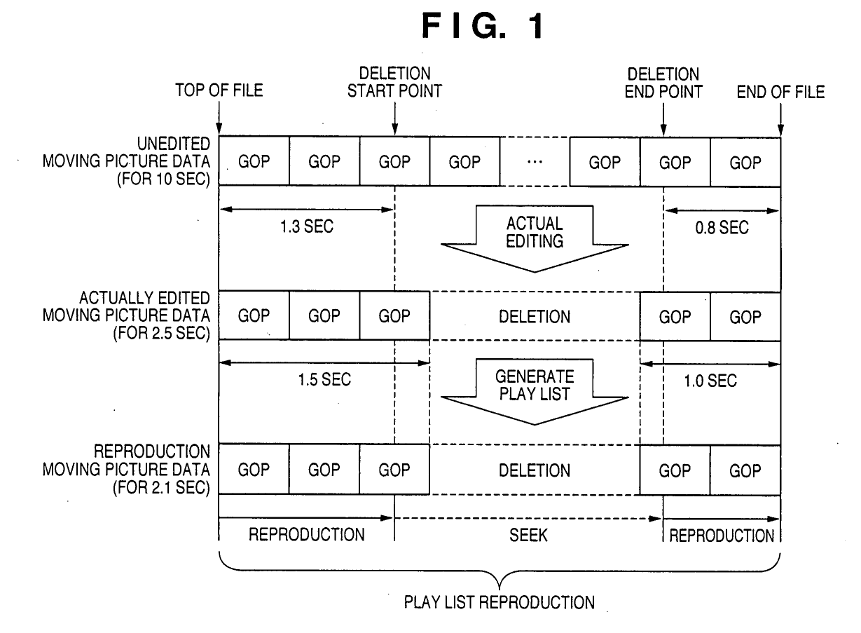

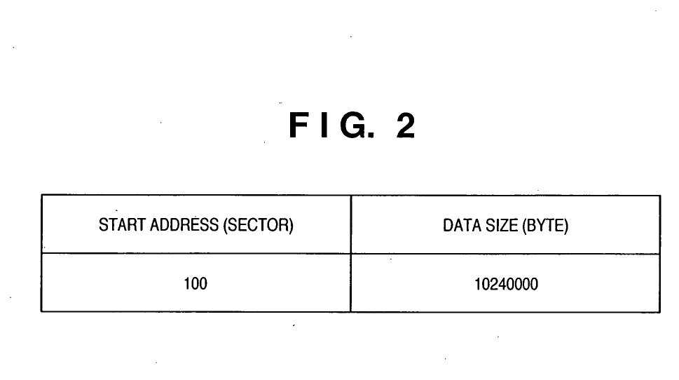

FIG. 1 shows a case where partial deletion in frame level editing is performed according to the present embodiment. As shown in FIG. 7, moving picture data is formed with GOPs. In FIG. 1, the moving picture data before editing has a length for 10 seconds corresponding to 20 GOPs. Further, the file size is 10,240,000 bytes, and the file system information of the moving picture data before editing is as shown in FIG. 2. That is, the 10,240,000 byte data (for 10 sec) is continuously recorded from a sector number 100.

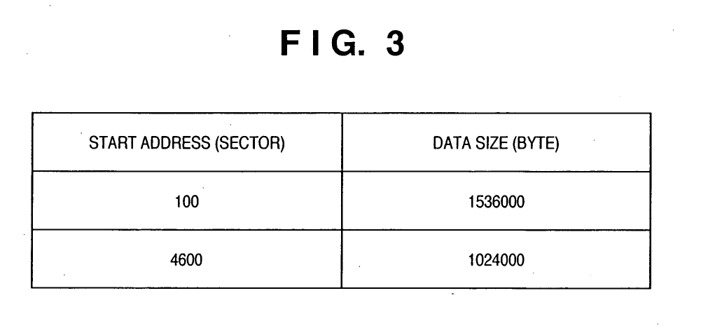

In a case where a user has requested to delete data from a deletion start point (position 1.3 sec from the top) to a deletion end point (position 9.2 sec from the top) in FIG. 1, i.e., in a case where the deletion start point and the deletion end point are in the middle of GOP, data from a GOP immediately after a GOP including the deletion start point (the 4th GOP in FIG. 1) to a GOP immediately before a GOP including the deletion end point (the 18th GOP in FIG. 1) is deleted, since upon reproduction of frame in the middle of GOP, an I frame at the top of the GOP is required and preceding and subsequent frames of a reproduced frame may be required. In actual deletion, the moving picture data itself is not necessarily rewritten but only the file system information (file management information) is updated. As shown in FIG. 7, as the size of Pack constituting the GOP is the same as the sector size in the file system, i.e., 2048 bytes, the boundary between GOPs always corresponds with that between sectors. As shown in FIG. 3, the file system information of actually edited moving picture data is divided to two areas. The first half area shows data of 15,360,000 bytes from a sector number 100 (for 1.5 sec), and the second half area shows data of 1,024,000 bytes from a sector number 4600 (for 1.0 sec). That is, data of 7,680,000 bytes (for 7.5 sec) has been actually deleted, and the deleted area can be overwritable with other data.

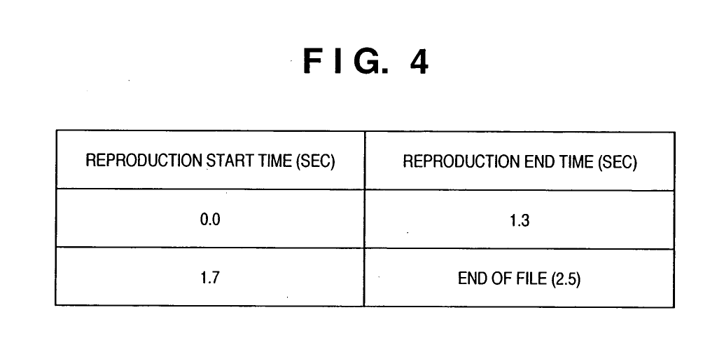

To reproduce the actually edited data in correspondence with the deletion start and end points designated by the user, a play list information as shown in FIG. 10 is generated. At this time, as the data initially corresponding to 10 seconds has been reduced to data for 2.5 seconds after the partial deletion, time designation must be performed for the actually edited data. FIG. 4 shows an actual play list information to reproduce the actually edited moving picture data. Reproduction is divided into two parts. Reproduction start times and reproduction end times correspond to a position from the top of the moving picture data to a position 1.3 seconds from the top, and a position 1.7 seconds from the top to the end of the moving picture data (position 2.5 sec from the top). The deletion end point designated by the user is a position 9.2 seconds from the top of the unedited moving picture data, however, as the data for 7.5 seconds has been deleted, the start position of the second half part corresponds to the position from 1.7 seconds from the top. When the actually edited moving picture data is reproduced based on the play list information, the portion designated by the user is deleted.

Finally, necessary portions of the related files are updated in correspondence with the partial deletion of the moving picture data. That is, thumbnails generated from the deleted portion are deleted, meta data information related to the deleted portion is deleted, and the time map table is rewritten. If necessary, the moving picture management file is updated.

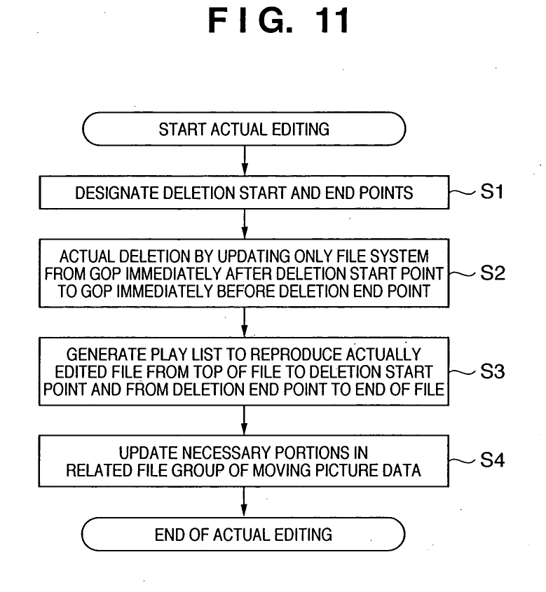

FIG. 11 is a flowchart showing the frame level editing processing as described above. The processing is performed by the CPU 101 in FIG. 14.

First, at step S1, a desired moving picture file is designated from the operation unit 12, and when designation of deletion start position and deletion end position has been detected, the process proceeds to step S2, at which data from a GOP immediately after a GOP designated with the deletion start position to a GOP immediately before a GOP designated with the deletion end position is deleted by updating the file system management information. Note that a sector which has held the deleted GOPs is newly rewritably released. Thus the data in a rough intermediate position between the deletion start position and the deletion end position is deleted.

Next, the process proceeds to step S3, at which a play list is generated in accordance with the actually designated deletion start position and the deletion end position. More specifically, the play list is generated so as to reproduce the data from the top of the file to a frame immediately before a frame in the deletion start position, then to reproduce the data from a frame immediately after the deletion end position to the end of the file.

Then the process proceeds to step S4, at which related files (thumbnail images and the like included in the deletion section) are updated in correspondence with the deletion.

Note that if the deletion start position corresponds to a frame to be reproduced at the top of GOP, the deletion is started with the GOP. Further, if the deletion end position corresponds to a frame to be reproduced at the last of GOP, the deletion is made to the GOP.

<Second Embodiment>

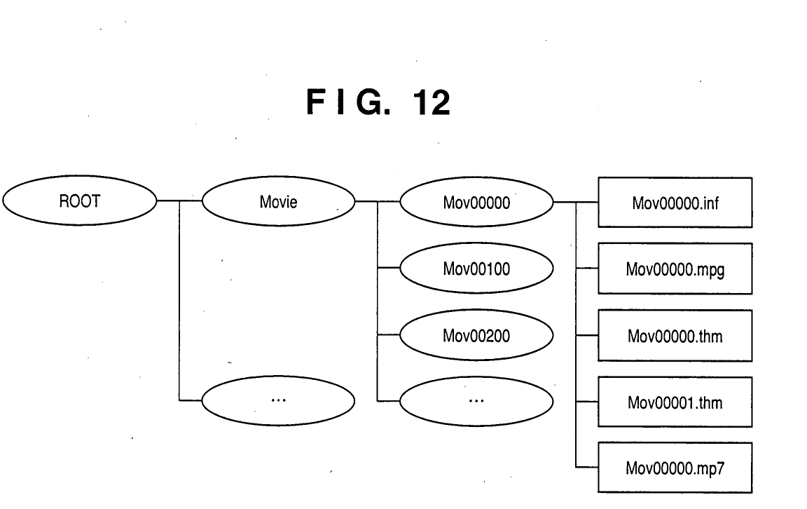

Next, an example where the time map information and the play list information are included in the moving picture management file will be described as a second embodiment. In this case, the directory structure is as shown in FIG. 12. In the directory structure, in comparison with FIG. 6, the time map information and the play list information do not exit, but the moving picture management file (.inf), the thumbnail file (.thm) and the meta data file (.mp7) other than the moving picture data main body exist.

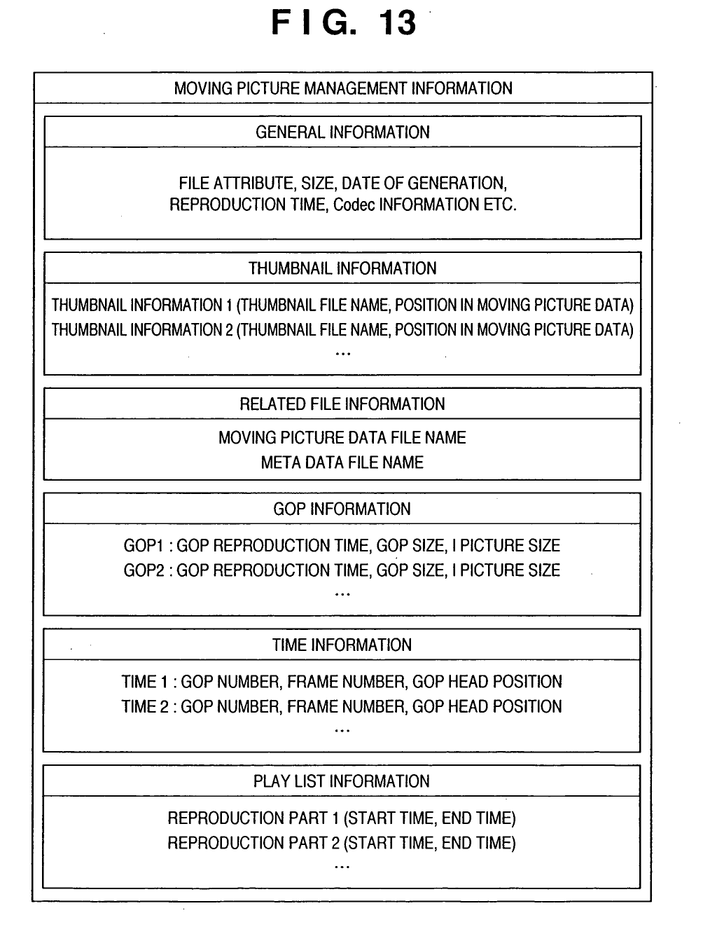

Further, as shown in FIG. 13, in the structure of the moving picture management file, the time map information in FIG. 9 and the play list information in FIG. 10 are added to the moving picture management file in FIG. 8, however, in the related file information, as link information to the time map information file and the play list file is not necessary, the information is omitted. Further, the actual editing by frame and the like are the same as those of the first embodiment.

Note that in the above-described first embodiment, the content of one play list file related to one moving picture data is changed in correspondence with data deletion, however, it may be arranged such that virtual editing can be performed by designating plural moving picture files recorded on a disk with a play list.

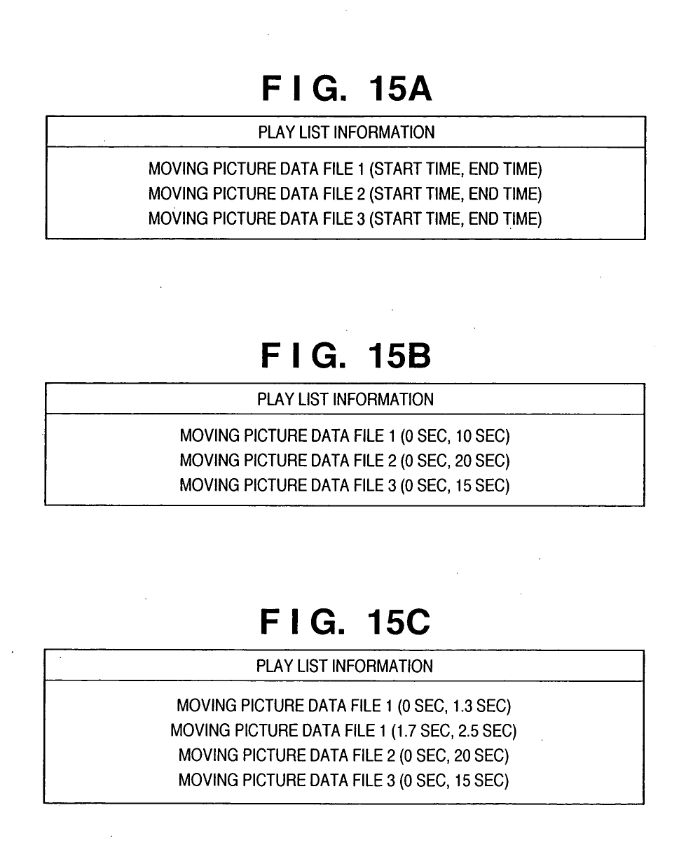

FIG. 15A shows the format of play list description to designate plural moving picture data files with one play list. The play list having the structure in FIG. 15A is stored in a PlayList directory generated under the ROOT directory in FIG. 6 separately from the Movie directory.

In FIG. 15A, the play list indicates that moving picture data files 1 to 3 are designated, and reproduced in this order. The play list describes information on reproduction start times and reproduction end times in the respective moving picture data files. The description of reproduction range in each moving picture data file is made in the same manner as that in the format shown in FIG. 10.

In accordance with partial deletion of moving picture data file as described above, the contents of the play list data in FIG. 15A are changed such that data from a deletion start position to a deletion end position of deletion-designated portion is deleted and the moving picture data is reproduced to the deletion start position then continuously from the deletion end position.

For example, in a case where the moving picture data files 1 to 3 are video clips for 10 seconds, 20 seconds and 15 seconds, the play list to reproduce these data from the tops of the files in this order is as shown in FIG. 15B.

In this status, if a part of the moving picture data file 1 as a 10 second clip is deletion-designated as in the case of FIG. 1, the contents of the play list are changed as shown in FIG. 15C.

In addition to the above-described embodiments, it is apparent that means for realizing the functions of the above embodiments can be realized as software. That is, the present invention includes a computer program in its scope. Further, as a computer program is generally stored on a computer-readable storage medium such as a CD-ROM and can be executed when the medium is set in a computer and duplicated or installed in the system there, the present invention also includes such computer-readable storage medium.

As described above, according to the present embodiment, in a moving picture data recording/reproduction apparatus where moving picture data is recorded on a disk medium, upon frame level actual editing, editing by GOP is performed by only updating a file system without changing the moving picture data itself, and upon reproduction, the moving picture data is reproduced by frame within a range designated by a user in accordance with play list information. Thus frame level actual editing can be performed only by updating a file system and generating a play list.

As described above, according to the present invention, in response to a request for deletion of intermediate portion of moving picture data stored on a random-accessible storage medium, data corresponding to the request is substantially deleted, and the portion of the deletion request is excluded from the subject of reproduction in precise frame units.

As many apparently widely different embodiments of the present invention can be made without departing from the spirit and scope thereof, it is to be understood that the invention is not limited to the specific embodiments thereof except as defined in the appended claims.

1. A moving picture editing apparatus for processing plural moving picture files respectively including coded moving picture data and play list data indicating a procedure of reproduction of said plural moving picture files recorded on a recording medium, comprising:
designation means for designating deletion start position and deletion end position of said moving picture data so as to request deletion of a part of said moving picture data, wherein said designation means being capable of designating said deletion start position and said deletion end position in smaller units than predetermined units related to coding processing on said moving picture data;
deletion processing means for, in correspondence with a deletion request from said designation means, deleting said moving picture data from said recording medium in the predetermined units related to the coding processing on said moving picture data; and
play list processing means for, in correspondence with the deletion request from said designation means, changing contents of said play list data so as to reproduce said moving picture data to said deletion start position and continuously from said deletion end position.

2. An apparatus according to claim 1, wherein in said play list data, a reproduction position of said moving picture data can be designated in frame units, and wherein said designation means is capable of designating said deletion start position and said deletion end position in frame units.

3. An apparatus according to claim 1, wherein said deletion processing means deletes said moving picture data by changing management information to manage the moving picture files recorded on said recording medium.

4. An apparatus according to claim 1, wherein said moving picture data is coded in accordance with the MPEG 2 coding, and wherein said deletion processing means deletes said moving picture data in GOP (Group Of Pictures) units.

5. An apparatus according to claim 1, wherein a related file group related to said moving picture file is also recorded on said recording medium, and said deletion processing means further changes contents of said related file group in correspondence with the deletion request from said designation means.

6. An apparatus according to claim 5, wherein said related file group includes a moving picture management file having size information of said moving image file, a representative image file having representative image data of said moving picture data, a meta data file and a time map information file indicating a data amount of said moving picture data per unit time.

7. an apparatus according to claim 1, wherein said recording medium includes a disk medium.

8. A moving picture editing apparatus for processing plural moving picture files including moving picture data in MPEG2-program stream format and play list data indicating a procedure of reproduction of said plural moving picture files recorded on a random-accessible recording medium, comprising:
designation means for designating deletion start position and deletion end position of said moving picture data so as to request deletion of a part of said moving picture data, wherein said designation means being capable of designating said deletion start position and said deletion end position in smaller units than the GOP units;
deletion means for, in correspondence with a deletion request from said designation means, changing contents of management information of said moving picture file, and deleting said moving picture data from said recording medium from a GOP immediately after a GOP including said deletion start position to a GOP immediately before a GOP including said deletion end position; and
play list processing means for, in correspondence with the deletion request from said designation means, changing contents of said play list data so as to reproduce said moving picture data to said deletion start position and continuously from said deletion end position.

9. A control method for a moving picture editing apparatus for processing plural moving picture files respectively including coded moving picture data and play list data indicating a procedure of reproduction of said plural moving picture files recorded on a recording medium, comprising:
a designation step of designating deletion start position and deletion end position of said moving picture data so as to request deletion of a part of said moving picture data, wherein at said designation step, said deletion start position and said deletion end position can be designated in smaller units than predetermined units related to coding processing on said moving picture data;
a deletion processing step of, in correspondence with a deletion request at said designation step, deleting said moving picture data from said recording medium in the predetermined units related to the coding processing on said moving picture data; and
a play list processing step of, in correspondence with the deletion request at said designation step, changing contents of said play list data so as to reproduce said moving picture data to said deletion start position and continuously from said deletion end position.

10. A method according to claim 9, wherein in said play list data, a reproduction position of said moving picture data can be designated in frame units, and wherein said designation means is capable of designating said deletion start position and said deletion end position in frame units.

11. A method according to claim 9, wherein at said deletion processing step, said moving picture data is deleted by changing management information to manage the moving picture files recorded on said recording medium.

12. A method according to claim 9, wherein said moving picture data is coded in accordance with the MPEG 2 coding, and wherein at said deletion processing step, said moving picture data is deleted in GOP (Group Of Pictures) units.

13. A method according to claim 9, wherein a related file group related to said moving picture file is also recorded on said recording medium, and at said deletion processing step, contents of said related file group are changed in correspondence with the deletion request at said designation step.

14. A method according to claim 13, wherein said related file group includes a moving picture management file having size information of said moving image file, a representative image file having representative image data of said moving picture data, a meta data file and a time map information file indicating a data amount of said moving picture data per unit time.

15. A method according to claim 9, wherein said recording medium includes a disk medium.

16. A control method for a moving picture editing apparatus for processing plural moving picture files including moving picture data in MPEG2-program stream format and play list data indicating a procedure of reproduction of said plural moving picture files recorded on a random-accessible recording medium, comprising:
a designation step of designating deletion start position and deletion end position of said moving picture data so as to request deletion of a part of said moving picture data, wherein at said designation step, said deletion start position and said deletion end position can be designated in smaller units than the GOP units;
a deletion step of, in correspondence with a deletion request at said designation step, changing contents of management information of said moving picture file, and deleting said moving picture data from said recording medium from a GOP immediately after a GOP including said deletion start position to a GOP immediately before a GOP including said deletion end position; and
a play list processing step of, in correspondence with the deletion request at said designation step, changing contents of said play list data so as to reproduce said moving picture data to said deletion start position and continuously from said deletion end position.
